(19) United States
(12) Patent Application Publication
(10) Pub. No.: US 2009/0157878 A1
(43) Pub. Date: Jun. 18, 2009

(54) METHOD AND SYSTEM FOR CONNECTING LOWER NODES TO ONE ANOTHER TO INCREASE SCALABILITY IN ZIGBEE NETWORK

(75) Inventors: Hyunhak KIM, Daejeon (KR); Noseong PARK, Daejeon (KR); Yoonmee DOH, Daejeon (KR); Sun-Joong KIM, Daejeon (KR)

Correspondence Address: Muncy, Geissler, Olds & Lowe, PLLC, P.O. BOX 1364, FAIRFAX, VA, 22038-1364, US

(73) Assignee: Electronics and Telecommunications Research Institute, Daejeon (KR)

(21) Appl. No.: 12/241,703

(22) Filed: Sep. 30, 2008

(30) Foreign Application Priority Data
Dec. 14, 2007 (KR) 10-2007-0130761

(51) Int. Cl. G06F 15/173

(52) U.S. Cl. 709/225

(57) ABSTRACT

Disclosed are a method and system for connecting lower nodes to one another to increase scalability in a ZigBee network. The method includes approving a participation request to excess lower nodes requesting participation in higher nodes where network addresses set with respect to the higher nodes are allocated to all of the lower nodes; when a transmission message is received from the excess lower nodes, analyzing the received transmission message and determining a node for transmitting the transmission message; and transmitting the transmitted transmission message to the determined node.

### CROSS-REFERENCE TO RELATED APPLICATION

This application claims priority from Korean Patent Application No. 10-2007-0130761, filed on Dec. 14, 2007, in the Korean Intellectual Property Office, the entire disclosure of which is incorporated herein by reference.

### BACKGROUND OF TIE INVENTION

1. Field of the Invention

The present invention relates to a method and system for connecting lower nodes to one another to increase scalability in a ZigBee network which may approve a network connection request of the lower nodes while exceeding a limitation in a maximum number of lower nodes which higher nodes are capable of having, thereby allowing the lower nodes to connect with a network.

This work was supported by the IT R&D program of MIC/IITA. [2006-S-601-02, Scalable method for managing and connecting for lower level nodes in ZigBee network]

2. Description of Related Art

ZigBee Alliance of a ZigBee network is a union organization having been co-founded by companies and organizations around the world in order to realize a local area wireless network of low-power and high efficiency based on Institute of Electrical and Electronics Engineers (IEEE) 802.15.4 standards.

The ZigBee network may be separated into a tree routing for transmitting data only using transmission between parent and children nodes in a tree formed by nodes, and into a mesh routing using an Ad Hoc On-demand Distance Vector (AODV) protocol. When forming the tree, a unique address value may be allocated to each of the nodes from higher nodes. In this instance, a depth first search may be performed in the tree, and thereby the address value may have a value such as an order offered to the nodes. Thus, a new address value is required to be allocated to each of the nodes when the node is moved to another position within the tree to join under a new parent node. Since there is a limitation in a maximum number (Cm) of children nodes (lower nodes) capable of being allocated to the parent node, a scheme for managing the children nodes (lower nodes) is required.

### SUMMARY OF THE INVENTION

An aspect of the present invention provides a method and system for connecting lower nodes to one another to increase scalability in a ZigBee network which may approve a network connection request of the lower nodes while exceeding a limitation in a maximum number of lower nodes capable of being allocated to higher nodes, thereby allowing the lower nodes to connect with a network.

According to an aspect of the present invention, there is provided a method for connecting lower nodes to one another to increase scalability in a ZigBee network, the method including: approving a participation request to excess lower nodes requesting participation in higher nodes where network addresses set with respect to the higher nodes are allocated to all of the lower nodes; when a transmission message is received from the excess lower nodes, analyzing the received transmission message and determining a node for transmitting the transmission message; and transmitting the transmitted transmission message to the determined node.

According to an aspect of the present invention, there is provided a system for connecting lower nodes to one another to increase scalability in a ZigBee network, the system including: a request approval unit to approve a participation request to excess lower nodes requesting participation in higher nodes where network addresses set with respect to the higher nodes are allocated to all of the lower nodes; a message processing unit to analyze a received transmission message to thereby determine a node for transmitting the transmission message, when the transmission message is received from the excess lower nodes; and a message transmission unit to transmit the transmitted transmission message to the determined node.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a configuration diagram illustrating a system for connecting lower nodes to one another to increase scalability in a ZigBee network according to an exemplary embodiment of the present invention;

FIG. 2 is a diagram illustrating an example of a system for connecting lower nodes to one another to increase scalability in a ZigBee network according to an exemplary embodiment of the present invention;

FIG. 3 is a diagram illustrating a state where a system for connecting lower nodes to one another to increase scalability in a ZigBee network according to an exemplary embodiment of the present invention transmits messages from excess lower nodes to a node via a higher node;

FIG. 4 is a diagram illustrating a state where a system for connecting lower nodes to one another to increase scalability in a ZigBee network according to an exemplary embodiment of the present invention transmits, to excess lower nodes, response messages transmitted by a node via a higher node;

FIG. 5 is a diagram illustrating a state where a system for connecting lower nodes to one another to increase scalability in a ZigBee network according to an exemplary embodiment of the present invention releases a network address of lower nodes excluded from a routing function, and preemptively allocates the released network address to lower nodes having the routing function;

FIG. 6 is a diagram illustrating a state where a system for connecting lower nodes to one another to increase scalability in a ZigBee network according to an exemplary embodiment of the present invention transmits, to a node via a higher node, messages from duplicated excess lower nodes using excess lower nodes having a routing function;

FIG. 7 is a diagram illustrating a state where a system for connecting lower nodes to one another to increase scalability in a ZigBee network according to an exemplary embodiment of the present invention transmits, to duplicated excess lower nodes via a higher node, response messages from a node using excess lower nodes having a routing function; and

FIG. 8 is a flowchart illustrating a method for connecting lower nodes to one another to increase scalability in a ZigBee network according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A node frequently used throughout this specification may designate a higher node or lower node of a specific node.

Also, a duplicated excess lower node may designate excess lower nodes (grandchildren nodes) belonging to excess lower nodes (children nodes) further belonging to a specific node.

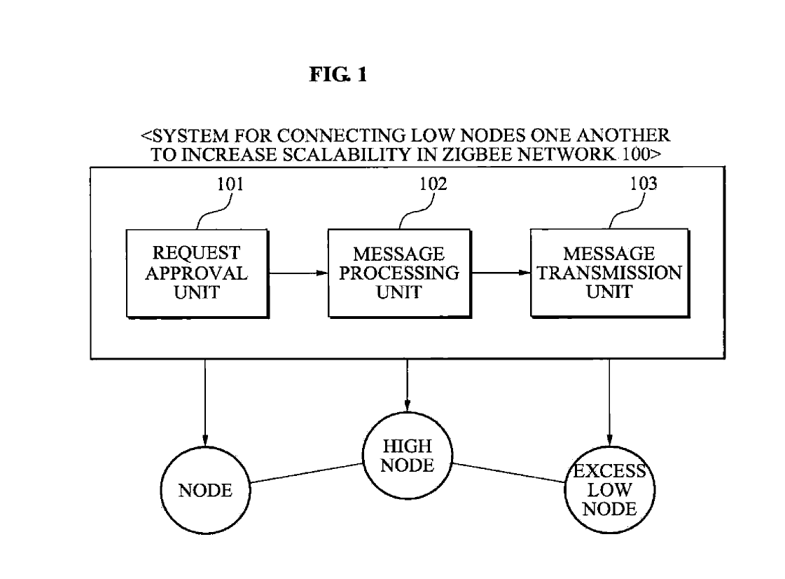

FIG. 1 is a configuration diagram illustrating a system 100 for connecting lower nodes to one another to increase scalability in a ZigBee network according to an exemplary embodiment of the present invention.

Referring to FIG. 1, the system 100 includes a request approval unit 101, a message processing unit 102, and a message transmission unit 103.

The request approval unit 101 may approve a participation request to excess lower nodes requesting participation in higher nodes where network addresses set with respect to the higher nodes are allocated to all of the lower nodes.

The message processing unit 102 may analyze the received transmission message to thereby determine a node for transmitting the transmission message, when a transmission message is received from the excess lower nodes.

Also, the message processing unit 102 may determine whether excess lower nodes have a routing function, and release allocation of network addresses allocated to the lower nodes excluded from the routing function from among the lower nodes to which the network addresses are allocated, when the excess lower nodes have the routing function according to the determined result. In addition, the message processing unit 102 may allocate, to the excess lower nodes, the network address in which the allocation is released.

Also, the message transmission unit 103 may transmit the transmitted transmission message to the determined node.

Also, the message transmission unit 103 may transmit, to the excess lower nodes, a confirmation message about whether the participation is approved when a request about the participation approval is received from the excess lower nodes.

The message processing unit 102 may record, in a table, the excess lower nodes in association with a message identifier for identifying a transmission message. In this instance, the message identifier is transmitted together with the transmission message. Also, the message processing unit 102 may receive, from the determined node, a response message in response to the transmission message, and retrieve, from the table, the excess lower nodes associated with the message identifier included in the received response message. The message identifier may be at least one of an order of a message, an arbitrary address of a network, and a hardware address of a message transmitting/receiving node.

Next, the message transmission unit 103 may transmit the response message to the retrieved excess lower nodes. Specifically, the message transmission unit 103 may transmit the response message to the excess lower nodes associated with the message identifier included in the response message.

When the excess lower nodes have the routing function, the message processing unit 102 may receive, from the excess lower nodes, the participation approval, and receive, from the duplicated excess lower nodes capable of performing communication, a duplicated transmission message via the excess lower nodes. Next the message processing unit 102 may analyze the received duplicated transmission message to thereby determine a node for transmitting the duplicated transmission message. Prior to this, the system 100 may additionally allocate a time slot to the excess lower nodes and allow duplicated excess lower nodes to request the excess lower nodes to approve a participation in the higher nodes.

Subsequently, the message transmission unit 103 may transmit the transmitted transmission message to the determined node.

The message processing unit 102 may record, in a table, the excess lower nodes in association with a message identifier for identifying a transmission message. In this instance, the message identifier may be transmitted together with the transmission message. Next, the message processing unit 102 may receive, from the determined node, a response message in response to the transmission message, and retrieves, from the table, the excess lower nodes associated with the message identifier included in the received response message. The message transmission unit may transmit the response message to the retrieved excess lower nodes.

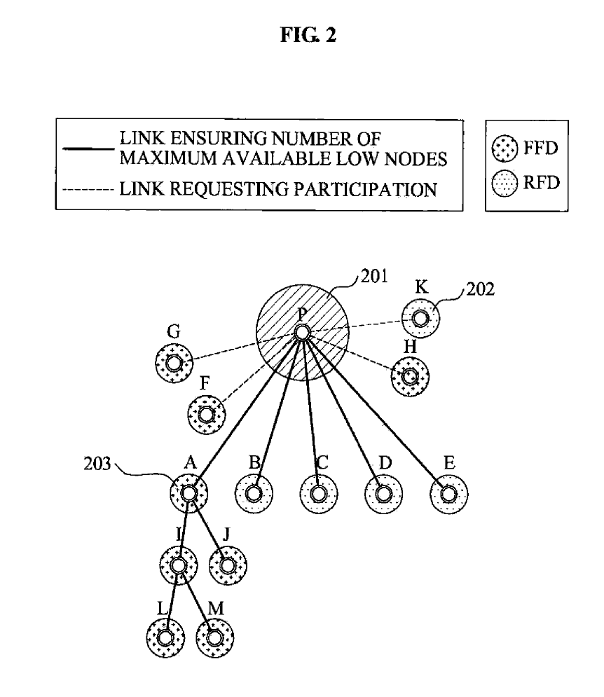

Hereinafter, referring to FIGS. 2 through 7, an example of a system for connecting lower nodes to one another to increase scalability in a ZigBee network according to the present invention will be described in detail.

FIG. 2 is a diagram illustrating an example of a system for connecting lower nodes to one another to increase scalability in a ZigBee network according to an exemplary embodiment of the present invention.

Referring to FIG. 2, a higher node 201 may manage to perform a communication with either lower nodes belonging to the higher node 201 or another higher node including the higher node 201, and to allocate a time slot and a network address to the lower node belonging to the higher node 201. The higher node 201 may allocate a network address to a lower node 203, and approve a participation in the excess lower node to an excess lower node 202 requesting the participation.

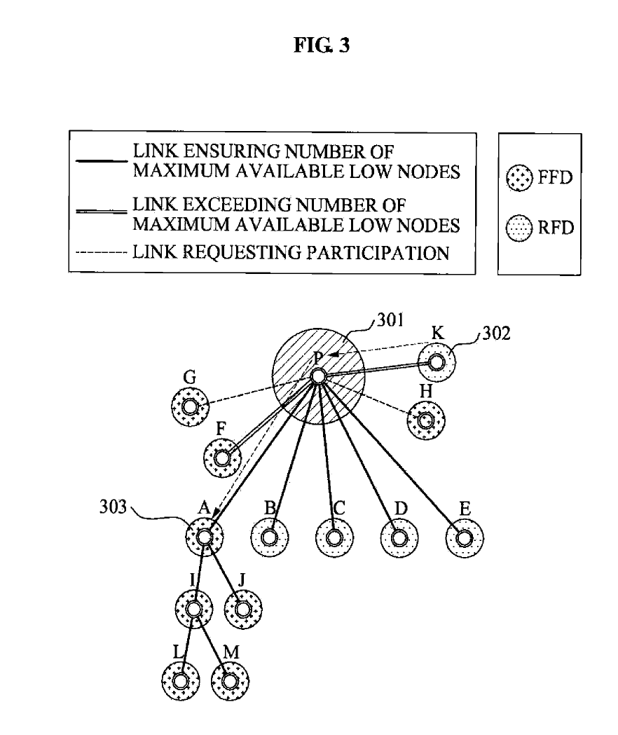

FIG. 3 is a diagram illustrating a state where a system for connecting lower nodes to one another to increase scalability in a ZigBee network according to an exemplary embodiment of the present invention transmits messages from excess lower nodes to a node via a higher node.

First, the message transmission unit may transmit, to an excess lower node 302, a confirmation message about whether the participation is approved, when a request for the participation is received from the excess lower node 302 requesting the participation.

The message processing unit may approve a participation in the higher node 301 to the excess lower node 302 requesting participation in the higher node 301 where network addresses set with respect to the higher node 301 are allocated to all of the lower nodes.

When a transmission message is received from the excess lower node 302, the message processing unit may analyze the received transmission message to thereby determine a node for transmitting the duplicated transmission message.

Also, the message processing unit may record, in a table, the excess lower node 302 in association with a message identifier for identifying the transmission message. In this instance, the message identifier may be transmitted together with the transmission message.

The message transmission unit may transmit the transmitted transmission message to the determined node 303.

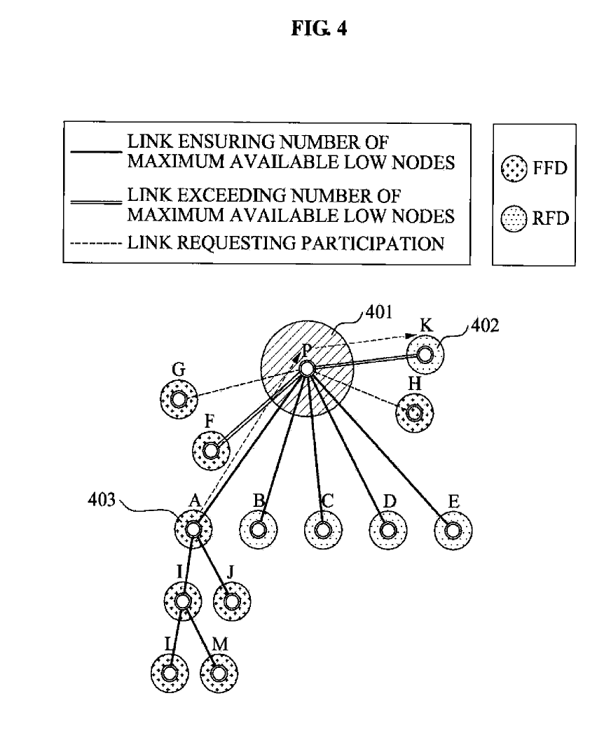

FIG. 4 is a diagram illustrating a state where a system for connecting lower nodes to one another to increase scalability in a ZigBee network according to an exemplary embodiment of the present invention transmits, to excess lower nodes, response messages transmitted by a node via a higher node.

When a response message is received from a determined node 403 in response to the transmission message, the message processing unit may retrieve, from the table, an excess lower node 402 associated with the message identifier included in the received response message.

The message transmission unit may transmit the response message to the retrieved excess lower node 402.

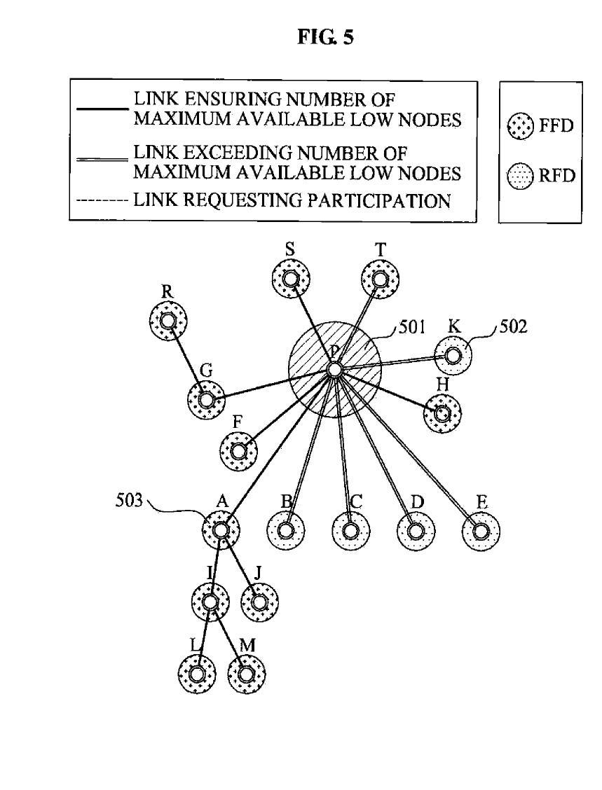

FIG. 5 is a diagram illustrating a state where a system for connecting lower nodes to one another to increase scalability in a ZigBee network according to an exemplary embodiment of the present invention releases a network address of lower nodes excluded from a routing function, and preemptively allocates the released network address to lower nodes having the routing function.

The system for connecting lower nodes to one another may determine whether an excess lower node has a routing function. When the excess lower node has the routing function according to the determined result, the system may release allocation of a network address allocated to a lower node 502 excluded from the routing function from among the lower nodes to which the network addresses are allocated, and allocate, to an excess node 503, the network address in which the allocation is released.

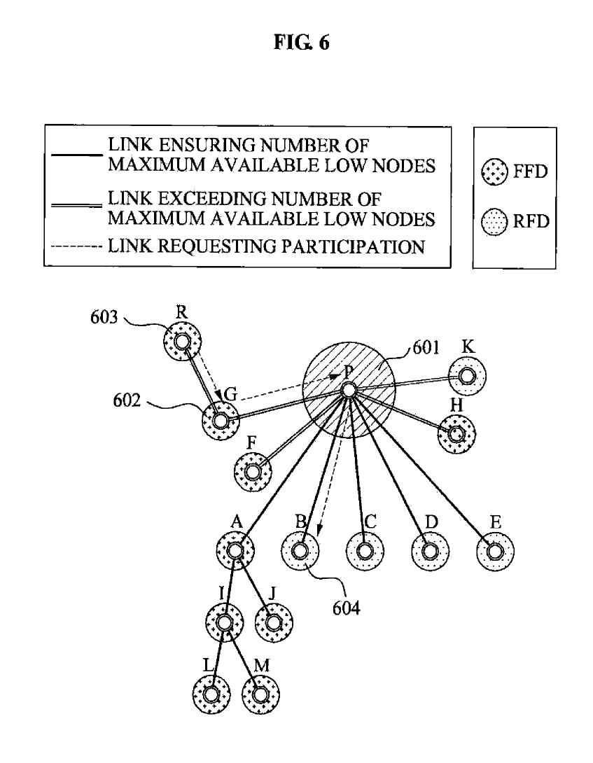

FIG. 6 is a diagram illustrating a state where a system for connecting lower nodes to one another to increase scalability in a ZigBee network according to an exemplary: embodiment of the present invention transmits, to a node via a higher node, messages from duplicated excess lower nodes using excess lower nodes having a routing function.

When an excess lower node 602 has a routing function, the system for connecting lower nodes to one another may receive, from the excess lower node 602, the participation approval, and allow the excess lower node 602 to receive, from a duplicated excess lower node 603 capable of performing a communication with the excess lower node 602, a transmission message. Next the system for connecting lower nodes to one another may record, in a table, the duplicated excess lower node 603 in association with a message identifier for identifying the transmission message. In this instance, the message identifier may be transmitted together with the transmission message. Subsequently, the system for connecting lower nodes to one another may allow a higher node 601 to receive the transmission message from the excess lower node 602, and record, in the table, the excess lower node 602 in association with the message identifier for identifying the transmission message. Subsequently, the system for connecting lower node to one another may analyze the transmission message to thereby determine a node 604 for transmitting the transmission message, and transmit the transmitted transmission message to the determined node 604.

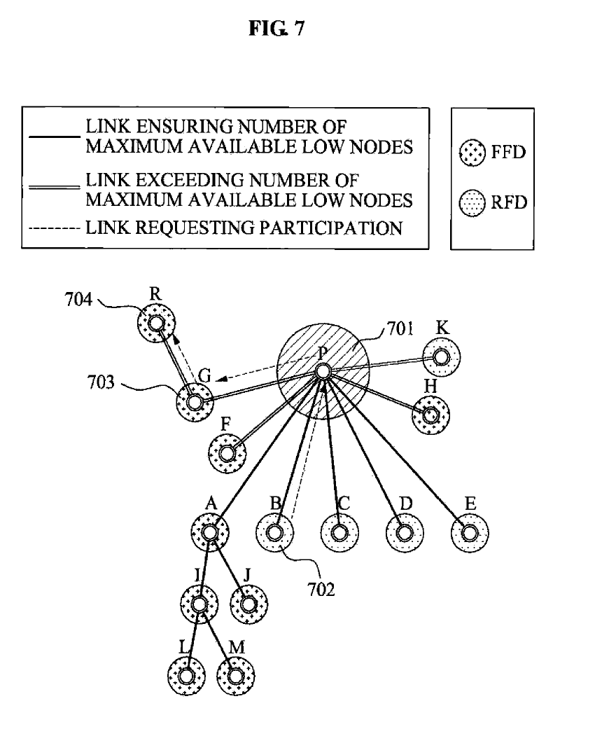

FIG. 7 is a diagram illustrating a state where a system for connecting lower nodes to one another to increase scalability in a ZigBee network according to an exemplary embodiment of the present invention transmits, to duplicated excess lower nodes via a higher node, response messages from a node using excess lower nodes having a routing function.

The system for connecting lower nodes to one another may allow a higher node 701 to receive, from a determined node 702, a response message in response to the transmission message, retrieve, from the table, an excess lower node 703 associated with the message identifier included in the received response message, and transmit the response message to the retrieved excess lower node 703.

Subsequently, the system for connecting lower nodes to one another may retrieve, from the table, a duplicated excess lower node 704 associated with the message identifier included in the received response message, and transmit the response message to the duplicated excess lower node 704.

Thus, according to the present invention, there is provided the method and system for connecting lower nodes to one another to increase scalability in a ZigBee network which may approve a network connection request of the lower nodes while exceeding a limitation in a maximum number of lower nodes capable of being allocated to higher nodes, thereby allowing the lower nodes to connect with a network.

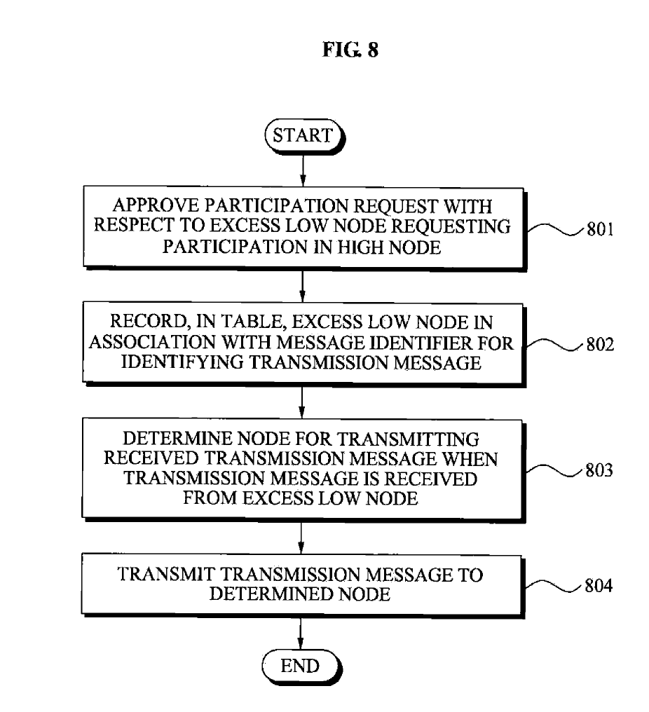

FIG. 8 is a flowchart illustrating a method for connecting lower nodes to one another to increase scalability in a ZigBee network according to an exemplary embodiment of the present invention.

In operation S801, the request approval unit of the system for connecting lower nodes to one another may approve a participation request in higher nodes to excess lower nodes requesting participation in higher nodes where network addresses set with respect to the higher nodes are allocated to all of the lower nodes.

When the request approval unit approves the participation request in the higher nodes to the excess lower nodes requesting the participation in the higher node, operation S801 may include a process for approving to allocate, to the excess lower node, a time slot required at the time of communication between the higher node and the excess lower node.

When the request approval unit approves the participation request in the higher nodes to the excess lower nodes having the routing function and requesting the participation in the higher node, operation S801 may include a process for approving to allocate, to the excess lower node, a time slot required at the time of communication between the excess lower node and the duplicated excess lower node later.

Prior to this, when the message transmission unit of the system for connecting lower nodes to one another receives, from the excess lower node, the participation approval in the higher node, operation S801 may include a process for transmitting, to the excess lower node, a confirmation message about whether the participation is approved.

In operation S802, the message processing unit of the system for connecting lower nodes to one another may record, in a table, the excess lower node in association with the message identifier for identifying the transmission message. In this instance, the message identifier may be transmitted together with the transmission message.

In operation S803, the message processing unit of the system for connecting lower nodes to one another may analyze a received transmission message to thereby determine a node for transmitting the transmission message, when the transmission message is received from the excess lower node.

In operation S804, the message transmission unit of the system for connecting lower nodes to one another may transmit the transmitted transmission message to the determined node.

As described above, according to the present invention, there is provided the method and system for connecting lower nodes to one another to increase scalability in a ZigBee network which may approve a network connection request of the lower nodes while exceeding a limitation in a maximum number of lower nodes capable of being allocated to higher nodes, thereby allowing the lower nodes to connect with a network.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for connecting lower nodes to one another to increase scalability in a ZigBee network, the method comprising:
approving a participation request to excess lower nodes requesting participation in higher nodes where network addresses set with respect to the higher nodes are allocated to all of the lower nodes;
when a transmission message is received from the excess lower nodes, analyzing the received transmission message and determining a node for transmitting the transmission message; and
transmitting the transmitted transmission message to the determined node.

2. The method of claim 1, further comprising:
transmitting, to the excess lower nodes, a confirmation message about whether the participation is approved when a request about the participation approval is received from the excess lower nodes.

3. The method of claim 1, further comprising:
recording, in a table, the excess lower nodes in association with a message identifier for identifying a transmission message, the message identifier being transmitted together with the transmission message;
receiving, from the determined node, a response message in response to the transmission message;
retrieving, from the table, the excess lower nodes associated with the message identifier included in the received response message; and
transmitting the response message to the retrieved excess lower nodes.

4. The method of claim 3, wherein the message identifier is at least one of an order of a message, an arbitrary address of a network, and a hardware address of a message transmitting/receiving node.

5. The method of claim 1, further comprising:
determining whether the excess lower nodes have a routing function;
releasing allocation of network addresses allocated to the lower nodes excluded from the routing function from among the lower nodes to which the network addresses are allocated, when the excess lower nodes have the routing function according to the determined result; and
allocating, to the excess lower nodes, the network address in which the allocation is released.

6. The method of claim 1, further comprising:
additionally allocating a time slot to the excess lower nodes and allowing duplicated excess lower nodes to request the excess lower nodes to approve a participation in the higher nodes, when the excess lower nodes have the routing function.

7. The method of claim 6, further comprising:
receiving, from the excess lower nodes, the participation approval, and receiving, from the duplicated excess lower nodes capable of performing communication, a duplicated transmission message via the excess lower nodes;
analyzing the received duplicated transmission message to thereby determine a node for transmitting the duplicated transmission message; and
transmitting the transmitted transmission message to the determined node.

8. The method of claim 7, further comprising:
recording, in a table, the excess lower nodes in association with a message identifier for identifying a transmission message, the message identifier being transmitted together with the transmission message;
receiving, from the determined nodes, a response message in response to the transmission message;
retrieving, from the table, excess lower nodes associated with the message identifier included in the received response message; and
transmitting the response message to the duplicated excess lower nodes via the retrieved excess lower nodes.

9. A system for connecting lower nodes to one another to increase scalability in a ZigBee network, the system comprising:
a request approval unit to approve a participation request to excess lower nodes requesting participation in higher nodes where network addresses set with respect to the higher nodes are allocated to all of the lower nodes;
a message processing unit to analyze a received transmission message to thereby determine a node for transmitting the transmission message, when the transmission message is received from the excess lower nodes; and
a message transmission unit to transmit the transmitted transmission message to the determined node.

10. The system of claim 9, wherein when a request about the participation approval is received from the excess lower nodes, the message transmission unit transmits, to the excess lower nodes, a confirmation message about whether the participation is approved.

11. The system of claim 9, wherein the message processing unit records, in a table, the excess lower nodes in association with a message identifier for identifying a transmission message, the message identifier being transmitted together with the transmission message, receives, from the determined node, a response message in response to the transmission message, and retrieves, from the table, the excess lower nodes associated with the message identifier included in the received response message, and
the message transmission unit transmits the response message to the retrieved excess lower nodes.

12. The system of claim 9, wherein the message processing unit determines whether the excess lower nodes have a routing function, when the excess lower nodes have the routing function according to the determined result, releases allocated network addresses allocated to the lower nodes excluded from the routing function from among the lower nodes to which the network addresses are allocated, and allocates, to the excess lower nodes, the network address in which the allocation is released.

13. The system of claim 9, wherein when the excess lower nodes have a routing function, the message processing unit receives, from the excess lower nodes, the participation approval, receives, from duplicated excess lower nodes capable of performing communication, a duplicated transmission message via the excess lower nodes, and analyzes the received duplicated transmission message to thereby determine a node for transmitting the duplicated transmission message, and
the message transmission unit transmits the transmitted transmission message to the determined node.

14. The system of claim 13, wherein the message processing unit records, in a table, the excess lower nodes in association with a message identifier for identifying a transmission message, the message identifier being transmitted together with the transmission message, receives, from the determined nodes, a response message in response to the transmission message, and retrieves, from the table, the excess lower nodes associated with the message identifier included in the received response message, and
the message transmission unit transmits the response message to the duplicated excess lower nodes via the retrieved excess lower nodes.
